(19) United States
(12) Patent Application Publication
(10) Pub. No.: US 2018/0289148 A1
(43) Pub. Date: Oct. 11, 2018

(54) Slope Adjustable Illuminated Art and Drafting Table

(71) Applicant: Studio Designs Inc., Commerce, CA (US)

(72) Inventor: Scott Maynes, Commerce, CA (US)

(21) Appl. No.: 15/995,527

(22) Filed: Jun. 1, 2018

Related U.S. Application Data
(60) Provisional application No. 62/610,894, filed on Dec. 27, 2017.

(51) Int. Cl. A47B 17/06; B43L 5/00; B43L 1/00; B43L 1/12; B43L 13/18; A47B 27/04

(52) U.S. Cl. CPC A47B 17/065; B43L 5/007; A47B 27/04; B43L 1/123; B43L 13/18; B43L 1/004

(57) ABSTRACT

A slope adjustable illuminated art and drafting table for drawing, writing, or impromptu sketching on large documents enables efficient access and storage of artistic or drafting supplies. The art and drafting table provides a base supported by a pair of arced legs. A work surface overlays the base. The work surface is illuminated and pivotally adjustable to slope between 0° and 35°. A hinged angle adjustment bracket fastens the work surface at the desired slope. The drafting table provides modular lower drawers that are interchangeable between left and right sides of the drafting table; an extendable shelf having a longitudinal lip for retaining marking instruments; and a pair of elongated partitioned lateral trays at the lateral edges of the work surface. The partitioned lateral trays are detachable and have depressions for holding artist instruments, paints, writing instruments, and other materials used by artist and draftsmen.

### CROSS REFERENCE OF RELATED APPLICATIONS

This application claims the benefits of U.S. provisional application no. 62/610,894, filed Dec. 27, 2017 and entitled ADJUSTABLE ARTIST CRAFT STATION, which provisional application is incorporated by reference herein in its entirety.

### FIELD OF THE INVENTION

The present invention relates generally to a slope adjustable illuminated art and drafting table. More so, an art and drafting table for drawing, painting, writing, or impromptu sketching on paper and large documents provides a work surface that is illuminated and pivotally adjustable between a 0° slope and a 35° slope relative to an underlying base; and further includes modular lower drawers that are interchangeable between left and right sides of the drafting table, an extendable shelf having a longitudinal lip for retaining marking instruments, and elongated, partitioned lateral trays disposed at the lateral edges of the work surface and configured to hold artist instruments, paints, writing instruments and other materials used by artist, draftsmen, and the like.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a drafting table, or art table is a multipurpose utility desk used for eclectic types of drawing, painting, writing, drafting, or impromptu sketching on a large sheet of paper. The drafting table is also effective for reading a large format book or other oversized document, and for drafting precise technical illustrations. The drafting table typically relies on a steel frame for support.

Generally, the table surface is a thick sheet of compressed fiberboard with sheets of Formica laminated to all its surfaces. The table surface is usually secured to the frame by screws which can easily be removed for drafting table transportation. The table surface is often covered with a thin vinyl sheet called a board cover, so as to provide an optimum surface for painting, drafting, and general markings.

Drawing or drafting requires a wide variety of pens and pencils, erasers, tape, templates, squares and triangles, bottles of ink and other drafting solutions. Drawing or drafting tables typically consist of a large slanted surface having few if any places to store or place the drawing tools. Because the drawing or drafting table is typically slanted, placing a pen, pencil or other implement on the table itself is impractical as the implement will simply roll or slide off. Occasionally trays or boxes are placed adjacent to the table, however, the drawing or drafting tools generally wind up in a clutter in such tray or box rendering efficient finding of a particular implement virtually possible.

Often, light tables include an open frame having a translucent cover, a light source located beneath the translucent cover, and a bottom closure overlying the projected area of the cover for reflecting light from the source through the cover. When a translucent or transparent medium containing a master drawing is placed on the cover and the light source is illuminated, the lines on the master drawing become visible through a tracing medium placed over the master allowing the subject matter on the master to be traced.

Other proposals have involved adjustable art and drafting desks. The problem with these desks is that they do not adjust in height and in the slope of the working surface. Nor do they provide illumination through the working surface. Even though the above cited art and drafting desks meets some of the needs of the market, an art and drafting table for drawing, painting, writing, or impromptu sketching on paper and large documents, and that provides a work surface that is illuminated and pivotally adjustable between a 0° slope and a 35° slope relative to an underlying base, is still desired.

### SUMMARY

Illustrative embodiments of the disclosure are generally directed to a slope adjustable illuminated art and drafting table. The slope adjustable illuminated art and drafting table is configured for an artist, drafter, and the like to draw, paint, write, or sketch impromptu pictures on a large sheet of paper or oversized document for constructing art work and drafting precise technical illustrations. The art and drafting table allows the artist or drafter to sit comfortably and work from multiple adjustable slopes on an illuminated working surface, while also storing artistic or drafting supplies in a convenient location in the drafting table for efficient access.

In some embodiments, the art and drafting table provides an illuminated work surface that is pivotally adjustable between a 0° slope and a 35° slope. The drafting table further provides a plurality of modular lower drawers that are interchangeable between left and right sides of the drafting table; an extendable shelf having a longitudinal lip for retaining marking instruments; and a pair of elongated partitioned lateral trays disposed at the lateral edges of the work surface for holding artist instruments, paints, writing instruments, measurement tools, images, files, communication devices, cameras, and other materials used by artist, draftsmen, and the like.

In one non-limiting embodiment, the art and drafting table, comprises a pair of arced legs disposed in a parallel spaced-apart relationship. The arced legs are defined by a ground end and a support end. The height of the legs is adjustable. The ground end comprises feet that operable to retract and extend in relation to the legs. At least one stabilizer bar is disposed between the legs. The stabilizer bar enhances the structural integrity of the art and drafting table.

In another embodiment, a base is disposed perpendicularly across the legs. The base is defined by a front base edge, a rear base edge, and a pair of lateral base edges. A pair of lateral brackets are disposed at the lateral base edges. A plurality of modular lower drawers are disposed adjacently to the base and detachably attachable to either of the lateral brackets. The modular lower drawers store an art and drafting related items. A pair of drawer support frames detachably attach to the lateral brackets. The drawer support frames enable slidable displacement of the modular lower drawers between an open position and a closed position.

In another embodiment, the art and drafting table comprises an extendable shelf that is defined by a flat surface, a front shelf edge, and a longitudinal lip extending across the front shelf edge. The extendable shelf slidably connects and slides along a pair of lateral sliding guard rails. While sliding, the extendable shelf is operable between a retracted position to retract beneath the base, and an extended position to extend beyond the front base edge of the base. The extendable shelf supports the art and drafting related item, whereby the longitudinal lip retains at least one marking instrument on the surface of the shelf.

In another embodiment, the art and drafting table comprises a work surface that is disposed to overlay the base. The work surface is at least partially transparent, and defined by a front surface edge, a rear surface edge, and a pair of lateral surface edges. An illumination portion emits light towards the work surface. The at least partially transparent configuration of the work surface enables passage of light through. A ledge extends from the front surface edge of the work surface to retain papers and items when the work surface is sloped.

A hinge assembly enables the work surface to pivot. The hinge assembly is operable between the front base edge and the front surface edge. The hinge assembly rotates the work surface across a plane, between a 0° slope and a 35° slope relative to the base. A hinged angle adjustment bracket is extendable between the base and the work surface. The angle adjustment bracket fixedly supports the work surface at the slope.

In another embodiment, the table comprises a pair of elongated partitioned lateral trays. The lateral trays are detachably attached to the lateral surface edges of the work surface. The partitioned lateral trays are defined by a plurality of depressions, or apertures, or both, whereby the partitioned lateral trays support the art and drafting related item.

In another aspect, the pair of arced legs form a generally bowed X-shape.

In another aspect, the base is generally flat and rectangular.

In another aspect, the work surface is generally flat and rectangular.

In another aspect, the work surface includes at least one of the following: a tempered blue safety glass, a clear glass, and a black glass.

In another aspect, the drafting table is fabricated from heavy gauge steel.

In another aspect, the longitudinal lip is disposed proximal to the front base edge of the base.

In another aspect, the angle adjustment bracket is hinged.

In another aspect, the plurality of modular lower drawers comprise three plastic molded slide-out drawers.

In another aspect, the depressions or apertures of the partitioned lateral trays are defined by a circular shape, a square, shape, a rectangular shape, and an irregular shape.

One objective of the present invention is to provide a stable and well-lighted working surface for an artist or drafter.

Another objective is to provide convenient storage options for storing the art and drafting related items, such as artist instruments, paints, writing instruments, measurement tools, images, files, communication devices, cameras, and other materials used by artist, draftsmen, and the like.

Another objective is to provide an illuminated, work surface.

Another objective is to provide an adjustable slope for the work surface to accommodate different types of projects.

Another objective is to provide extended working surface areas through use of an extendable shelf.

Another objective is to provide removable drawers and trays.

Another objective is to provide an inexpensive to manufacture drafting table.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary adjustable drafting table with exemplary modular lower drawers on the left side, in accordance with an embodiment of the present invention;

FIG. 2 illustrates a perspective view of the adjustable drafting table shown in FIG. 1 with the modular lower drawers on the right side, in accordance with an embodiment of the present invention;

FIG. 3 illustrates a frontal view of an adjustable drafting table, in accordance with an embodiment of the present invention;

FIG. 4 illustrates a perspective view of the adjustable drafting table shown in FIG. 3, showing the work surface sloped up to 35°, in accordance with an embodiment of the present invention;

FIG. 5 illustrates an elevated side view of the adjustable drafting table shown in FIG. 3, showing the work surface sloped up to 35°, in accordance with an embodiment of the present invention;

FIG. 6 illustrates a perspective rear view of the adjustable drafting table shown in FIG. 3, showing the work surface sloped up to 35°, in accordance with an embodiment of the present invention;

FIG. 7 illustrates a close up view of exemplary modular lower drawers retracted in a closed position and extended into an open position, in accordance with an embodiment of the present invention;

FIG. 8 illustrates a close up view of an exemplary extendable shelf retracted into the adjustable drafting table, in accordance with an embodiment of the present invention;

FIG. 9 illustrates a close up view of an exemplary extendable shelf having a longitudinal lip and fully extended, in accordance with an embodiment of the present invention;

FIG. 10 illustrates a close up view of an exemplary hinge assembly disposed about 2″ from a lateral bracket, in accordance with an embodiment of the present invention;

FIG. 11 illustrates a close up view of an exemplary partitioned lateral tray attached to the adjustable drafting table, in accordance with an embodiment of the present invention;

FIG. 12 illustrates a perspective view of a first series of components for the adjustable drafting table, in accordance with an embodiment of the present invention;

FIG. 13 illustrates a perspective view of a second series of components for the adjustable drafting table, in accordance with an embodiment of the present invention;

FIG. 14 illustrates a perspective view of a third series of components for the adjustable drafting table, in accordance with an embodiment of the present invention;

FIG. 15 illustrates a perspective view of a fourth series of components for the adjustable drafting table, in accordance with an embodiment of the present invention; and

FIG. 16 illustrates a perspective view of a fifth series of components for the adjustable drafting table, in accordance with an embodiment of the present invention,

Like reference numerals refer to like parts throughout the various views of the drawings.

### DETAILED DESCRIPTION OF THE INVENTION

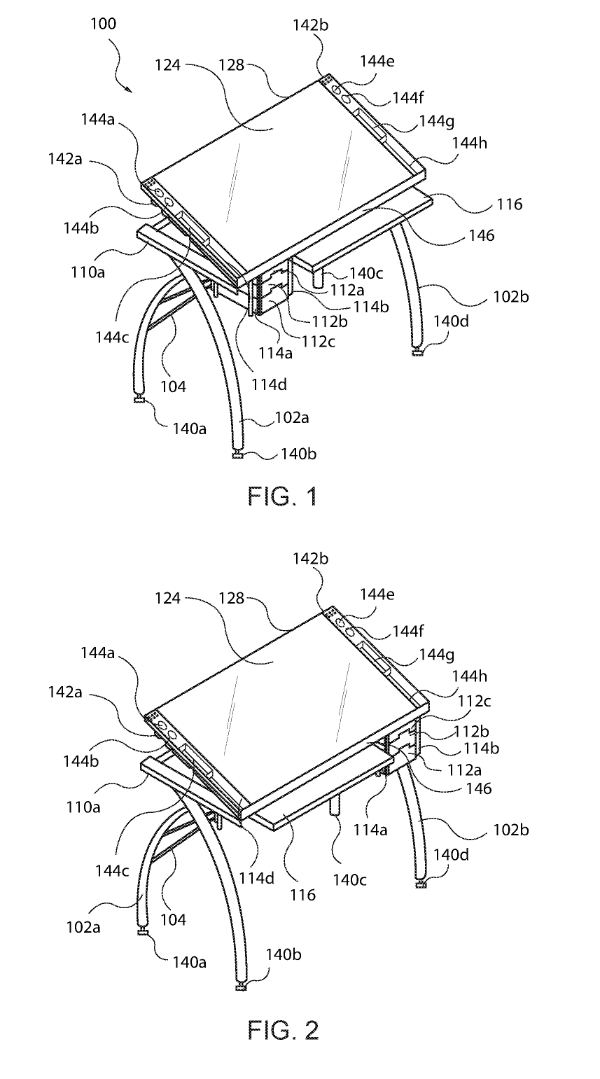

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112a, 112b, 112c.

In one embodiment of the present invention presented in FIGS. 1-16, a slope adjustable illuminated art and drafting table 100 is configured to serve as a unique utility and crafting desk for an artist or drafter to design art work and draft precision documents. The slope adjustable illuminated art and drafting table 100, hereafter “table 100”, allows the artist and drafter to draw, paint, write, measure, or sketch impromptu pictures on a large sheet of paper or oversized document, so as to design art work (paintings, portraits) and draft precise technical illustrations (engineering drawings or architectural drawings). The table 100 is unique in that the artist or drafter may sit comfortably while working from multiple adjustable slopes on an illuminated surface. The table also provides multiple accessible and reconfigurable drawers and depressed trays for storing artistic or drafting supplies in a convenient location that is easy and efficient to access.

As referenced in FIG. 1, the table 100 comprises a pair of arced legs 102a-b that are disposed in a parallel spaced-apart relationship. The arced legs 102a-b are defined by a ground end 138a and a support end 138b. In one non-limiting embodiment, the arced legs 102a-b form a generally bowed X-shape. In one non-limiting embodiment, each arced leg 102a, 102b is about 31.5″ long. Though in alternative embodiments, the arced legs 102a-b are length adjustable to accommodate various sizes of artist or drafters and respective chairs. In one embodiment, the ground end 138a of the legs 102a-b comprises feet 140a, 140b, 140c, 140d that retract and extend in relation to the legs 102a-b (FIG. 2). This allows the height of the legs 102a-b to be adjusted through rotational or vertical incremental manipulation of the feet 140a-d.

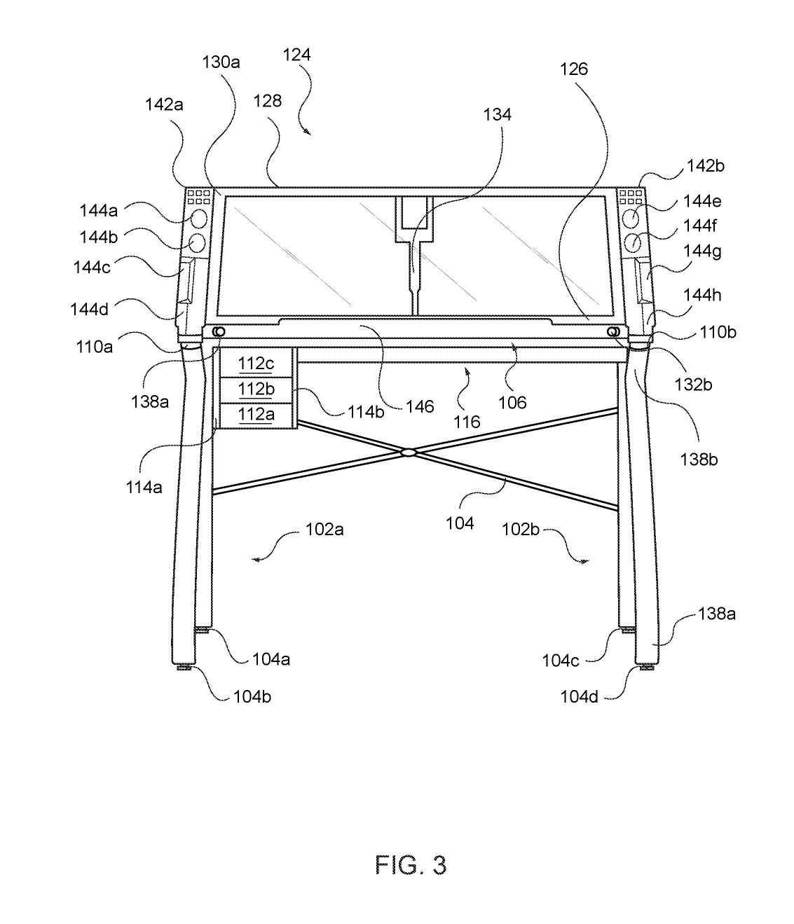

Turning now to FIG. 3, at least one stabilizer bar 104 is disposed between the arced legs 102a-b. The stabilizer bar 104 may be rigid or semi-rigid. The stabilizer bar 104 enhances the structural integrity of the table 100. The stabilizer bar 104 reinforces the structural integrity of the arced legs 102a-b, and the table 100 in general. In one embodiment, the stabilizer bar 104 includes a pair of arced bars that extend between each set of legs 102a-b.

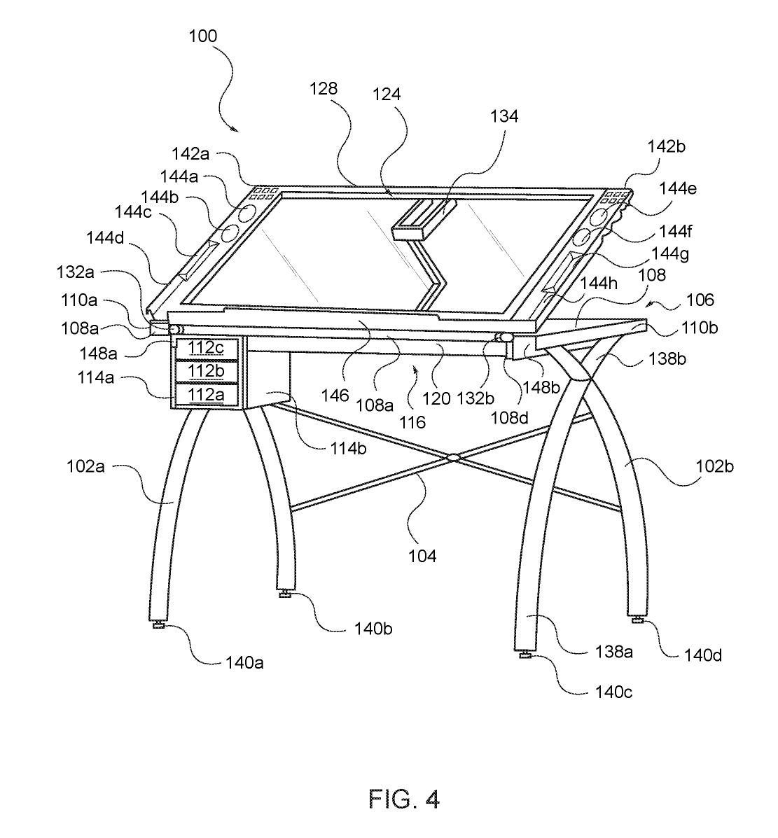

As FIG. 4 shows, the table 100 may also provide a base 106 that provides support and structural integrity for the table 100. The base 106 is disposed perpendicularly across the arced legs 102a-b. The base 106 is defined by a front base edge 108a, a rear base edge 108b, and a pair of lateral base edges 108c, 108d. The front base edge 108a is oriented towards where an artist or drafter sits at the table 100. The rear base edge 108b is oriented distally from the artist or drafter.

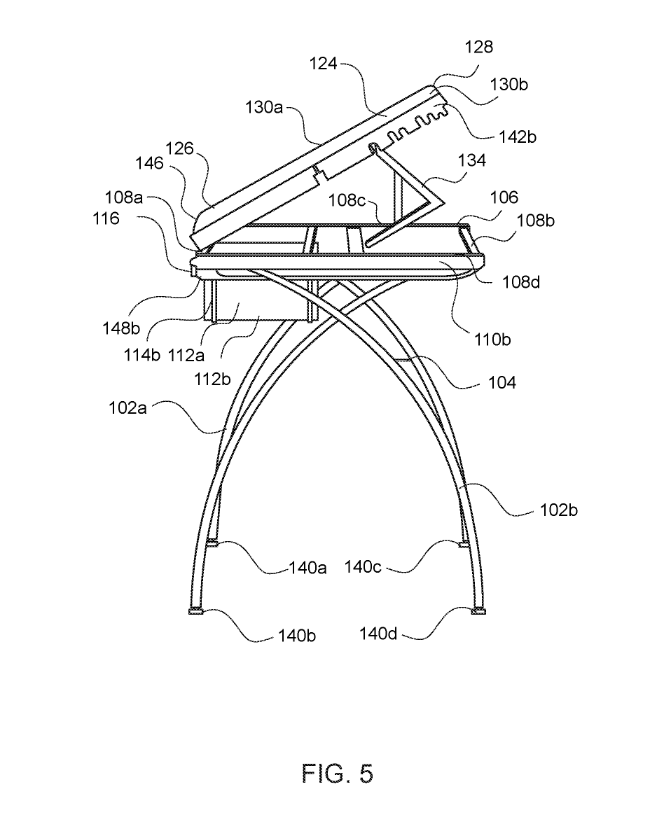

Turning now to FIG. 5, the base 106 may be generally flat and rectangular. In another embodiment, the base 106 comprises a rectangular frame with a series of parallel rods extending lengthwise. In one non-limiting embodiment, the base 106 has a width of 43.25″ and a depth of 24″. Though in other embodiments, the base 106 may be defined by other shapes and dimensions.

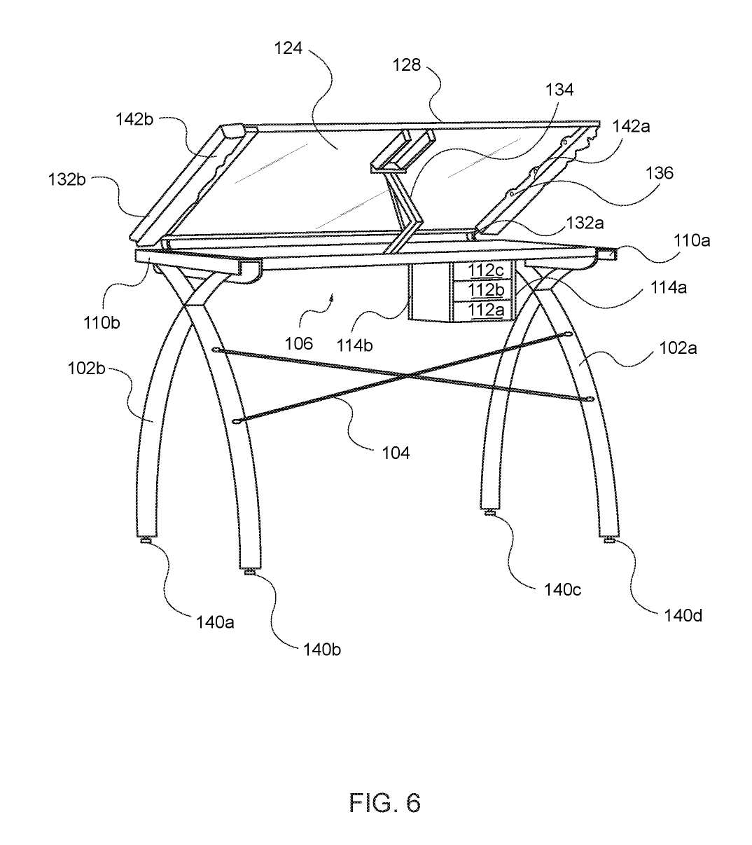

As referenced in FIG. 6, a pair of lateral brackets 110a-b are disposed adjacent to the lateral base edges 108c, 108d of the base. The lateral brackets 110a-b provide structural integrity, and enable sliding and fastening by other components of the table 100. The lateral brackets 110a-b may include steel or aluminum based support members that have rails, groves, or holes for various fastening and sliding functions. Suitable materials for the lateral brackets 110a-b may include, without limitation, steel, aluminum, or a metal alloy.

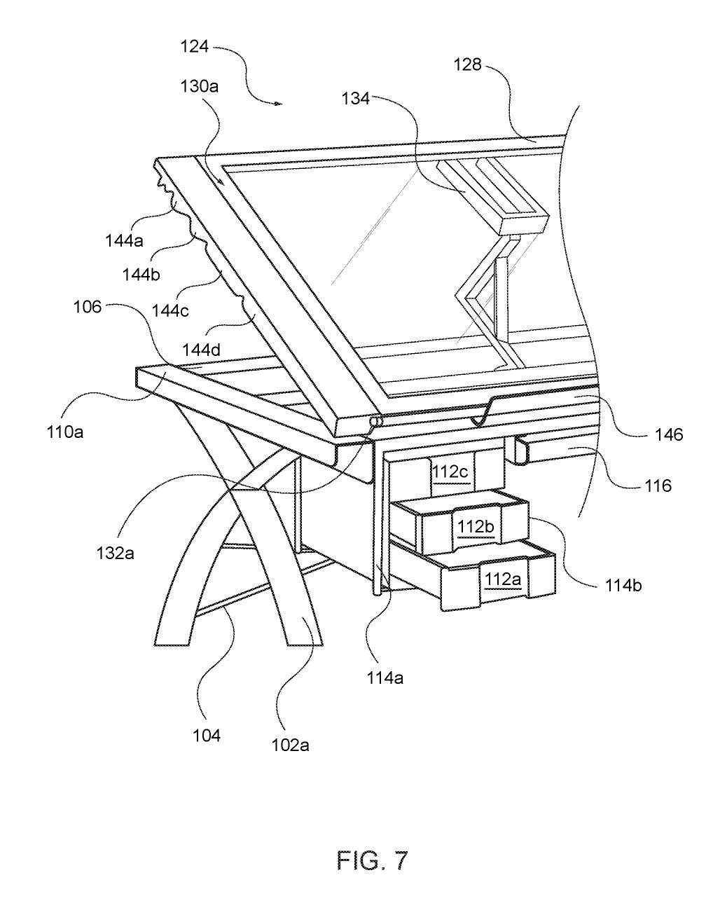

As shown in FIG. 7, the table 100 further provides a plurality of modular lower drawers 112a, 112b, 112c. The modular lower drawers 112a-c are disposed adjacently to the base 106, generally proximal to the front base edge 108a. The lower drawers 112a-c slide between an open position and a closed position. The modular lower drawers 112a-c are also unique in that they detachably attach to either of the lateral brackets—the left lateral bracket 110a, or the right lateral bracket 110b.

This is illustrated in FIG. 1, which shows the lower drawers 112a-c on the left side of the table 100; and FIG. 2, which shows the drawers 112a-c attached to the right side of the table 100. This interchangeable feature of the table 100 allows the modular lower drawers 112a-c to be accessed by the left hand or the right hand. Further, by differentiating storage capacity on a left or right side, organizational means are enhanced. This interchangeability is possible is because the modular lower drawers 112a-c have drawer support frames 114a-b that the lower drawers 112a-c attach. The drawer support frames 114a-b detachably attach to the lateral brackets 110a-b.

The drawer support frames 114a-b enable slidable displacement of the modular lower drawers 112a-c between an open position and a closed position. This may be possible through a pair of rails and guides that create a sliding relationship, as known in the art. The open position of the lower drawers 112a-c provides access to the interior of the drawers, while the closed position secures the drawers beneath the base 106. In this manner, the modular lower drawers 112a-c can securely and discretely store an art and drafting related item. In one non-limiting embodiment, the plurality of modular lower drawers 112a-c comprise three plastic molded slide-out drawers. Though in other embodiments, various shapes and materials of drawers 112a-c can be used.

In one possible embodiment, a pair of drawer support frames 114a-b detachably attach to the lateral brackets 110a-b and enable slidable displacement of the modular lower drawers 112a-c between an open position and a closed position. The drawer support frames 114a-b may include bars that extend vertically and attach to the base 106. As discussed above, the lower drawers 112a-c are reconfigurable to detach and attach for operation on the left side of the artist or drafter (FIG. 1), and the right side of the artist or drafter (FIG. 2). This is easily accomplished by detaching fasteners from the drawer support frames 114a, 114b on the left side of the base 106, and reattaching to the right side of the base 106. The lower drawers 112a-c then slide along the drawer support frames 114a-b from the same side.

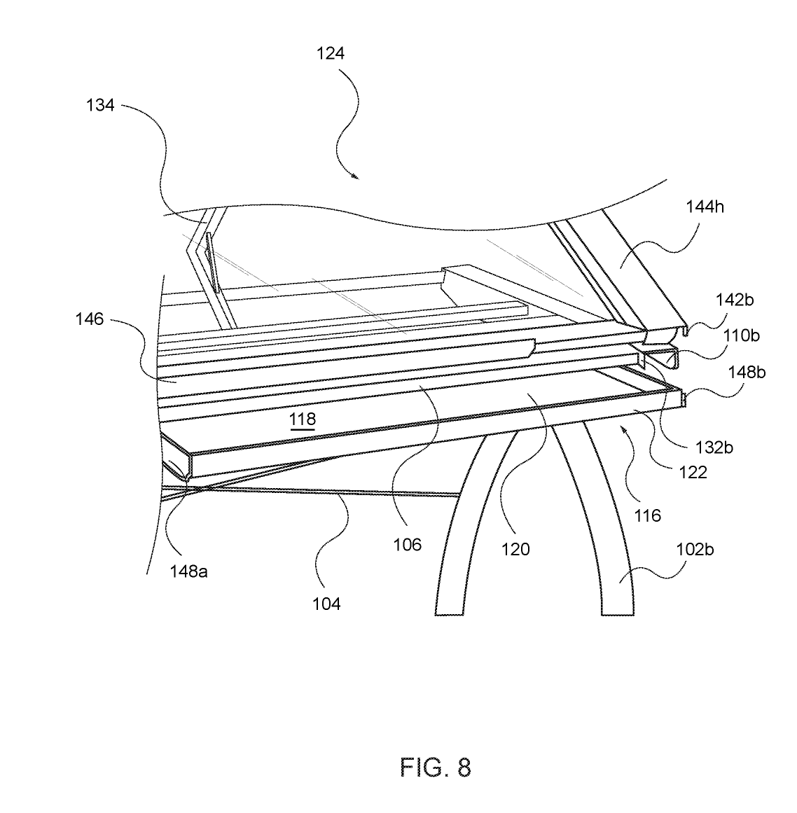

FIG. 8 illustrates a close up view of an exemplary extendable shelf 116 retracted into the table 100. The extendable shelf 116 that creates greater working and storage area for the table 100. The extendable shelf 116 is defined by a flat surface 118, a front shelf edge 120, and a longitudinal lip 122 extending across the front shelf edge 120. The shelf 116 provides a secondary working surface for the artist or draftsman.

In other embodiments, the extendable shelf 116 is slidably connected to a pair of lateral sliding guide rails bars 148a, 148b that extend between the front and rear base edges 108a-b of the base 106. The extendable shelf 116 is operable between a retracted position disposed to retract beneath the base 106, and an extended position disposed to extend beyond the front base edge 108a of the base 106, whereby the extendable shelf 116 supports the art and drafting related item, whereby the longitudinal lip 122 retains at least one marking instrument on the surface 118 of the shelf 116.

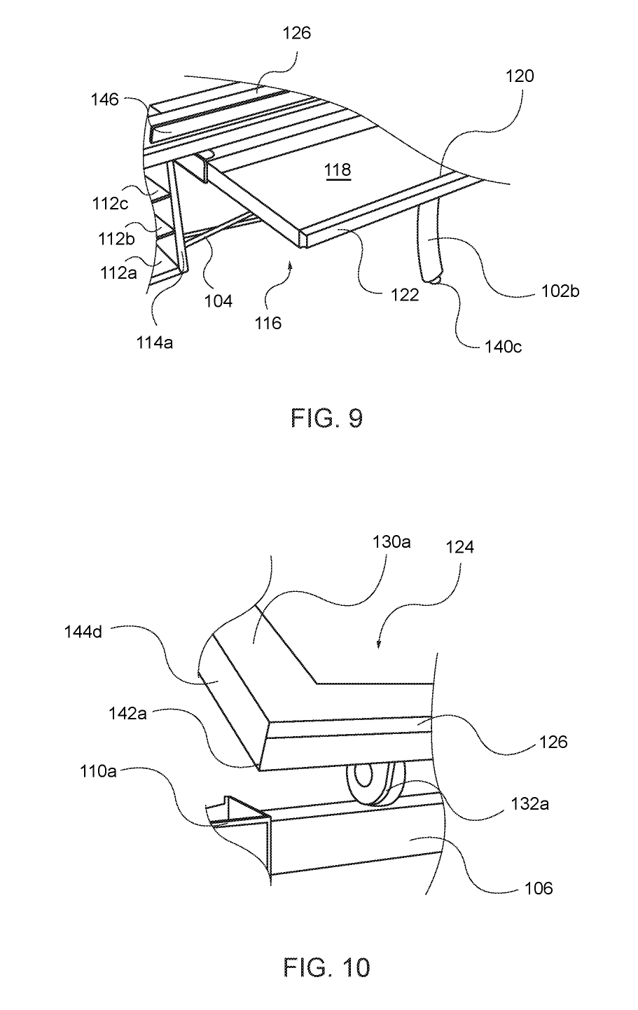

In one embodiment shown in FIG. 9, the lip 122 is about 24″ long. The longitudinal lip 122 is disposed proximal to the front base edge 108a of the base 106. In this manner, the lip 122 is proximal to an artist or drafter sitting at the table 100. The artist or drafter can hold a writing instrument, such as a pen or pencil, in the longitudinal lip 122, and have it in front for easy access.

Turning back to FIG. 3, a work surface 124 is disposed to overlay the base 106. The work surface 124 is the primary surface upon which papers, pens, art supplies, and drafting-related items are applied to produce the art or drafting composition. The work surface 124 is configured to support these items in a manner that allows writing, measuring, painting, and other artistic and drafting functions.

In one non-limiting embodiment, the work surface 124 is defined by a front surface edge 126, a rear surface edge 128, and a pair of lateral surface edges 130a-b. The front surface edge 126 may include a ledge 146 that retains paperwork and other items on the working surface 124. The ledge 146 is especially useful when the working surface 124 is sloped. Similar to the base 106, the work surface 124 is generally flat and rectangular. Though in other embodiments, the work surface 124 may take other shapes and dimensions.

The work surface 124 is at least partially transparent, so as to enable light to pass through for illuminating the work on the surface. The transparency aspect also enhances the ornamental effect of the table 100. In some embodiments, the work surface 124 may be fabricated from a tempered blue safety glass, a clear glass, a black glass, and a one-way glass. Various films and color filters may also be applied to the surface. Though in other embodiments, the work surface 124 may be fabricated from any material that is at least partially transparent.

To enhance the transparency characteristics of the work surface 124, an illumination portion 136 may be used to emit light towards the work surface 124. The light from the illumination portion 136 passes through the work surface 124 to enhance visibility of the artistic or drafting project. The illumination portion 136 may include, without limitation, a halogen bulb, Incandescent bulbs, halogen, neon lights, and a fluorescent bulb. The illumination portion 136 may be integrated into the work surface 124, or attached to the lateral brackets 110a-b or base frame. In one embodiment, the illumination portion 136 creates a glowing or lighted effect on the medium being worked on the work surface 124 for enhanced viewing.

Turning to the close up view of FIG. 10, the table 100 also provides a hinge assembly 132a-b that is operable between the front base edge 108a and the front surface edge 126. The hinge assembly 132a-b enables the work surface 124 to pivot between a 0° slope and a 35° slope relative to the base 106. Though in other embodiments, other slopes are possible. The hinge assembly 132a-b may include a pair of spaced-apart barrel hinges, known in the art. In one novel aspect, shown in FIG. 10, the hinge assembly 132a-b is spaced-apart about 2″ from the lateral tray 142a, so as to provide greater area to operate on the work surface 124.

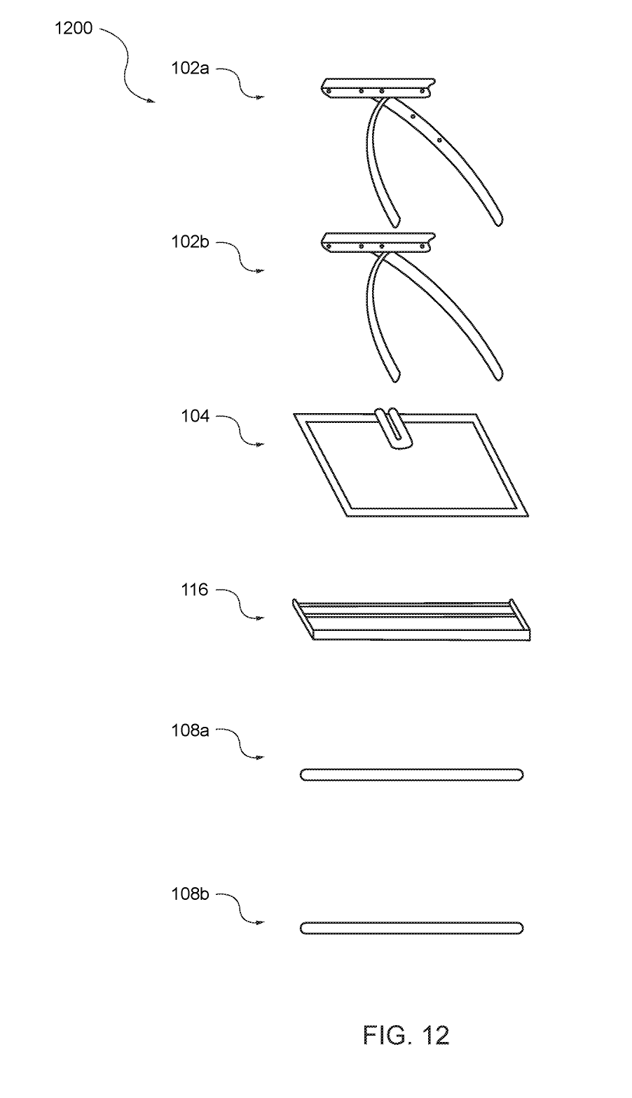

As FIGS. 4-6, and the list of components shown in FIGS. 12-16 reference, the table 100 provides an angle adjustment bracket 134 that is extendable between the base 106 and the work surface 124. In one embodiment, the angle adjustment bracket 134 is hinged. The angle adjustment bracket 134 is configured to fasten hingedly extend and retract, so as to securely retain the work surface 124 in a sloped disposition. For example, holding the work surface 124 at a 15° slope.

In one possible embodiment, the angle adjustment bracket 134, the base 106, and the lateral brackets 110a-b are fabricated from heavy gauge steel. The steel frame foundation allows the angle adjustment bracket 134 and other mechanical linkages to be installed that control both the height and angle of the work surface 124 relative to the base 106.

Looking again at FIG. 4, the table 100 further provides a pair of elongated partitioned lateral trays 142a-b. The partitioned lateral trays 142a-b are detachably attachable to the lateral surface edges 130a-b of the work surface 124 to enable access by both the left and right hands when storing and accessing art and drafting related items. Suitable materials for the lateral trays 142a, 142b may include, without limitation, polyurethane, polyvinyl chloride, rubber, metal, and a rigid polymer.

In some embodiments, the partitioned lateral trays 142a-b are defined by a plurality of depressions 144a-h, or apertures, or both. The depressions 144a-h provide a cavity in the partitioned lateral trays 142a-b to receive the art and drafting related items. In some embodiments, the depressions 144a-h or apertures may be defined by a circular shape, a square, shape, a rectangular shape, and an irregular shape. This variation in depression sizes enables the partitioned lateral trays 142a-b to hold an eclectic assortment of art and drafting related supplies.

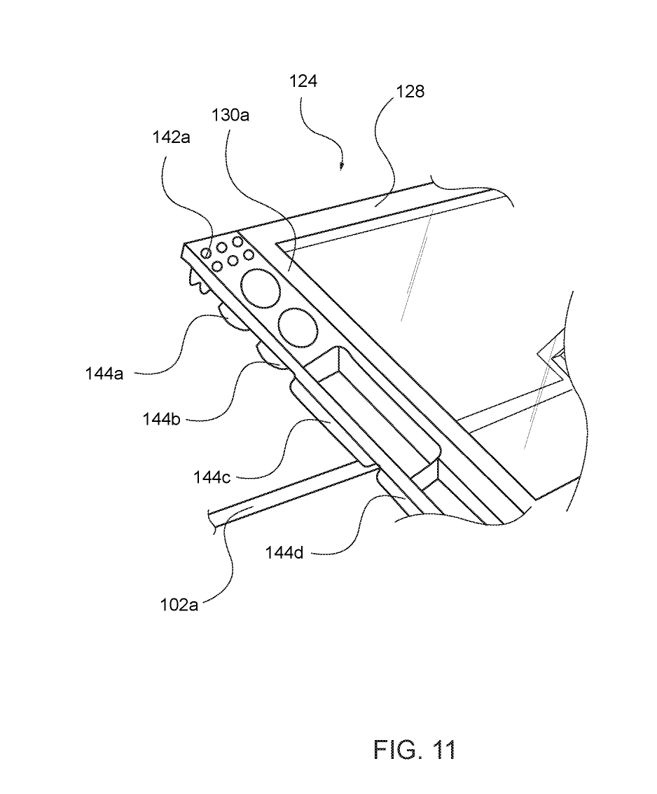

For example, FIG. 11 illustrates a close up view of the left lateral tray 142a forming two circular depressions 144a, 144b; one rectangular depression 144c; and one elongated slotted depression 144d. Similarly, the right lateral tray 144b forms two circular depressions 144e, 144f; one rectangular depression 144g; and one elongated slotted depression 144h. The circular depressions can retain erasers, tape, templates, squares and triangles, bottles of paint or ink, and other drafting solutions. The rectangular depressions can retain erasers, tape, templates, squares and triangles, and bottles of paint or ink. The elongated slotted depressions can contain pencils, pens, and slide rulers.

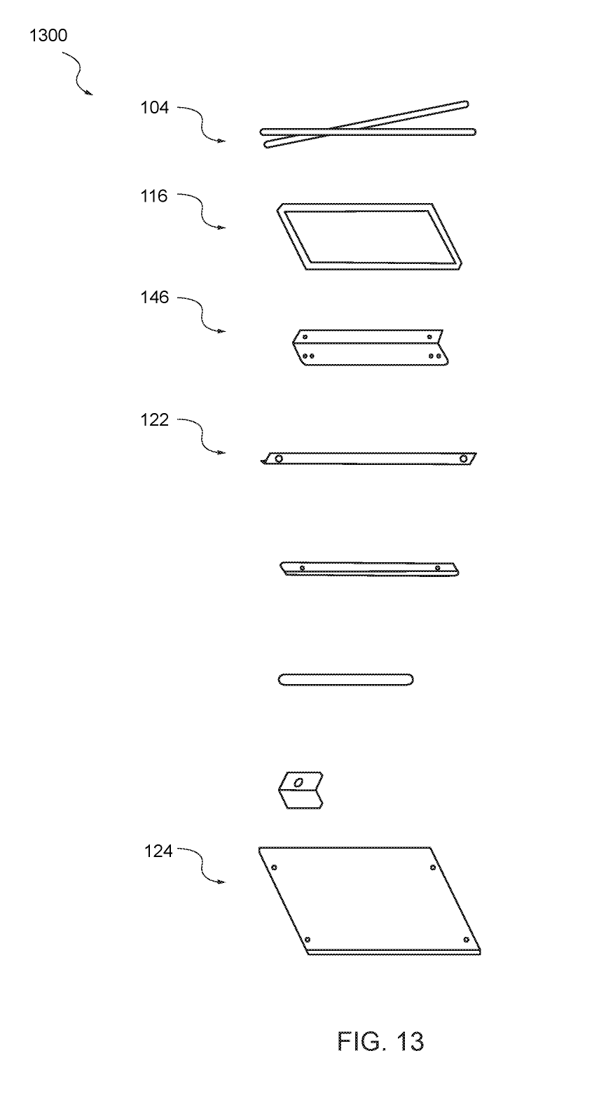

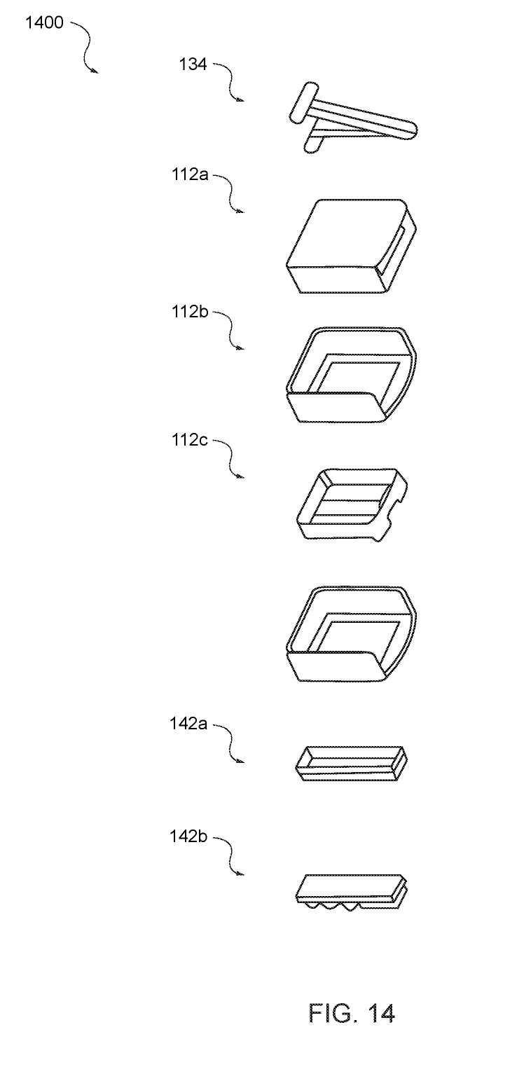

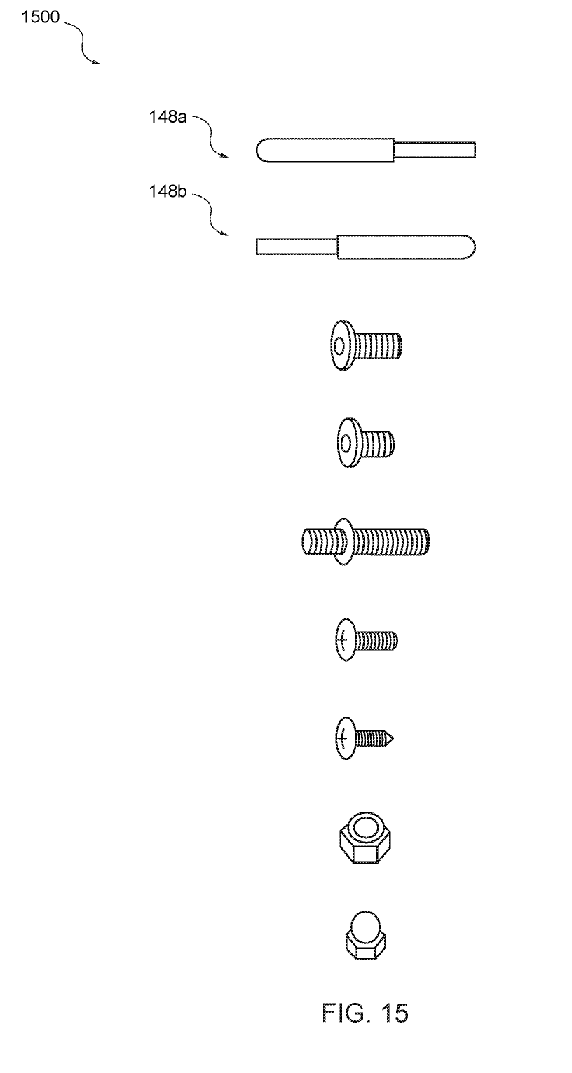

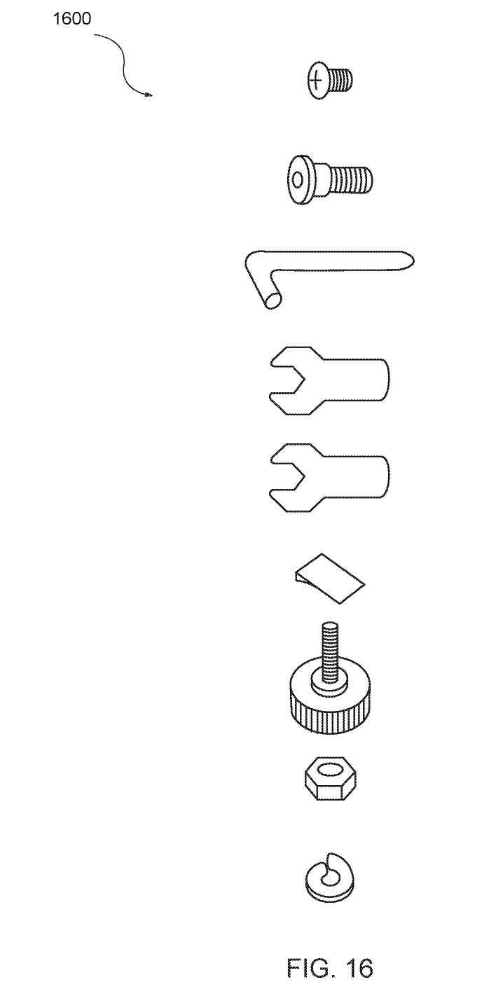

The various components discussed above, including ancillary nuts, bolts, washers, and the like, are illustrated in FIGS. 12-16. For example, FIG. 12 illustrates a perspective view of a first series 1200 of components for the adjustable drafting table. FIG. 13 illustrates a perspective view of a second series 1300 of components for the adjustable drafting table. FIG. 14 illustrates a perspective view of a third series 1400 of components for the adjustable drafting table. FIG. 15 illustrates a perspective view of a fourth series 1500 of components for the adjustable drafting table. FIG. 16 illustrates a perspective view of a fifth series 1600 of components for the adjustable drafting table.

One exemplary assemblage of the table 100 requires minimal tools or skills to accomplish. Initially, the arced legs 102a-b are positioned in a vertical, spaced-apart arrangement, so as to have mounted thereon the other components of the table 100. The base 106 and stabilizer bar 104 are then attached through various fastening mechanisms, such as screws, bolts, and the like. Next, the work surface 124 is placed into position, along with the angle adjustment bracket. The angle adjustment bracket is placed between the rear base edge 108b of the base 106 and the work surface 124, so as to be able to extend and retract to the desired slope.

Next, the drawer support frame for the drawers is attached to the base 106. The modular lower drawers 112a-c and the extendable shelf 116 are then put into place. The lateral brackets 110a-b and the portioned lateral trays 142a-b are installed next, with the partitioned lateral trays 142a-b nested between the work surface 124 and the lateral brackets 110a-b. The final steps involve sliding the lower drawers 112a-c into their respective position in the drawer support frames 114a-b. The table 100 is now ready for use.

In operation, an artist or drafter sits at the front edge of the table 100. The artist or drafter accesses the modular lower drawers 112a-c by pulling them out to the open position. The artist or drafter access the extended shelf by pulling it out to the extended position. In this manner, papers, pencils, paint, and other supplies can be placed thereon. The artist or drafter also has access to the left or right partitioned lateral trays 142a-b to access items contained therein.

The artist or drafter may then adjust the slope of the work surface 124 to achieve a desired working position. The slope is set by locking the angle adjustment bracket 134 under the work surface 124. The artist or drafter may also illuminate the work surface 124 by powering on the illumination portion. The artist or drafter is now in a position to work on an artistic or drafting project and have access to the appropriate supplies.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A slope adjustable illuminated art and drafting table, the table comprising:
a pair of arced legs disposed in a parallel spaced-apart relationship, the legs defined by a ground end and a support end, the ground end comprising a plurality of feet operable to retract and extend in relation to the legs, whereby manipulating the feet adjusts the height of the legs;
at least one stabilizer bar traversing the arced legs, the stabilizer bar enhancing the structural integrity of the legs;
a base disposed perpendicularly across the support end of the legs, the base defined by a front base edge, a rear base edge, and a pair of lateral base edges;
a pair of lateral brackets disposed along the lateral base edges of the base;
a plurality of modular lower drawers disposed adjacently to the base, the lower drawers detachably attachable to either of the lateral brackets;
a plurality of drawer support frames detachably attachable to the lateral brackets, the drawer support frames having a slidable relationship with the lower drawers, whereby the lower drawers slide along the drawer support frames to extend to an open position and retract to a closed position;
an extendable shelf defined by a flat surface, a front shelf edge, and a longitudinal lip, the longitudinal lip extending across the front shelf edge;
a pair of lateral sliding guide rails bars extending between the front and rear base edges of the base, whereby the extendable shelf slides along the lateral sliding guide rails bars to extend and retract, whereby the extendable shelf is operable to extend beyond the front base edge of the base, and retract beneath the base;
a work surface disposed to overlay the base, the work surface defined by a front surface edge, a rear surface edge, and a pair of lateral surface edges, the work surface being at least partially transparent;
an illumination portion emitting light towards the work surface;
a ledge extending from the front surface edge of the work surface;
a hinge assembly operable between the front base edge and the front surface edge, the hinge assembly enabling the work surface to pivot between a 0° slope and a 35° slope relative to the base;
an angle adjustment bracket extendable between the base and the work surface, the angle adjustment bracket securing the work surface at a fixed slope; and
a pair of elongated partitioned lateral trays detachably attachable to the lateral surface edges of the work surface, the partitioned lateral trays defined by a plurality of depressions.

2. The drafting table of claim 1, wherein the pair of arced legs form a generally bowed X-shape.

3. The drafting table of claim 1, wherein the base is generally flat and rectangular.

4. The drafting table of claim 1, wherein the work surface is generally flat and rectangular.

5. The drafting table of claim 1, wherein the work surface includes at least one of the following: a tempered blue safety glass, a clear glass, and a black glass.

6. The drafting table of claim 1, wherein at least a portion of the drafting table is fabricated from heavy gauge steel.

7. The drafting table of claim 1, wherein the longitudinal lip is disposed proximal to the front base edge of the base.

8. The drafting table of claim 1, wherein the angle adjustment bracket is hinged.

9. The drafting table of claim 1, wherein the plurality of modular lower drawers comprise three plastic molded slide-out drawers.

10. The drafting table of claim 1, wherein the depressions formed in the partitioned lateral trays are defined by at least one of the following shapes: a circular shape, a square, shape, a rectangular shape, and an irregular shape.

11. The drafting table of claim 1, wherein the lateral sliding guard rails comprise rolling wheels.

12. A slope adjustable illuminated art and drafting table, the table comprising:
a pair of arced legs disposed in a parallel spaced-apart relationship, the legs defined by a ground end and a support end, the ground end comprising a plurality of feet operable to retract and extend in relation to the legs, whereby manipulating the feet adjusts the height of the legs, the pair of arced legs forming a generally bowed X-shape;
at least one stabilizer bar traversing the arced legs, the stabilizer bar enhancing the structural integrity of the legs;
a base disposed perpendicularly across the support end of the legs, the base defined by a front base edge, a rear base edge, and a pair of lateral base edges;
a pair of lateral brackets disposed along the lateral base edges of the base;
a plurality of modular lower drawers disposed adjacently to the base, the lower drawers detachably attachable to either of the lateral brackets;
a plurality of drawer support frames detachably attachable to the lateral brackets, the drawer support frames having a slidable relationship with the lower drawers, whereby the lower drawers slide along the drawer support frames to extend to an open position and retract to a closed position;
an extendable shelf defined by a flat surface, a front shelf edge, and a longitudinal lip, the longitudinal lip extending across the front shelf edge, disposed proximal to the front base edge of the base;
a pair of lateral sliding guide rails bars extending between the front and rear base edges of the base, whereby the extendable shelf slides along the lateral sliding guide rails bars to extend and retract, whereby the extendable shelf is operable to extend beyond the front base edge of the base, and retract beneath the base;
a work surface disposed to overlay the base, the work surface defined by a front surface edge, a rear surface edge, and a pair of lateral surface edges, the work surface being at least partially transparent, the work surface having a generally rectangular shape;
an illumination portion emitting light towards the work surface;
a ledge extending from the front surface edge of the work surface;
a hinge assembly operable between the front base edge and the front surface edge, the hinge assembly enabling the work surface to pivot between a 0° slope and a 35° slope relative to the base;
an angle adjustment bracket extendable between the base and the work surface, the angle adjustment bracket securing the work surface at a fixed slope; and
a pair of elongated partitioned lateral trays detachably attachable to the lateral surface edges of the work surface, the partitioned lateral trays defined by a plurality of depressions.

13. The drafting table of claim 12, wherein the work surface includes at least one of the following: a tempered blue safety glass, a clear glass, and a black glass.

14. The drafting table of claim 12, wherein at least a portion of the drafting table is fabricated from heavy gauge steel.

15. The drafting table of claim 12, wherein the angle adjustment bracket is hinged.

16. The drafting table of claim 12, wherein the plurality of modular lower drawers comprise three plastic molded slide-out drawers.

17. The drafting table of claim 12, wherein the depressions formed in the partitioned lateral trays are defined by at least one of the following shapes: a circular shape, a square, shape, a rectangular shape, and an irregular shape.

18. The drafting table of claim 12, wherein the lateral sliding guard rails comprise rolling wheels.

19. A slope adjustable illuminated art and drafting table, the table consisting of:
a pair of arced legs disposed in a parallel spaced-apart relationship, the legs defined by a ground end and a support end, the ground end comprising a plurality of feet operable to retract and extend in relation to the legs, whereby manipulating the feet adjusts the height of the legs, the pair of arced legs forming a generally bowed X-shape;
at least one stabilizer bar traversing the arced legs, the stabilizer bar enhancing the structural integrity of the legs;
a base disposed perpendicularly across the support end of the legs, the base defined by a front base edge, a rear base edge, and a pair of lateral base edges, at least a portion of the base being fabricated from heavy gauge steel;
a pair of lateral brackets disposed along the lateral base edges of the base;
a plurality of modular lower drawers disposed adjacently to the base, the lower drawers detachably attachable to either of the lateral brackets;
a plurality of drawer support frames detachably attachable to the lateral brackets, the drawer support frames having a slidable relationship with the lower drawers, whereby the lower drawers slide along the drawer support frames to extend to an open position and retract to a closed position;
an extendable shelf defined by a flat surface, a front shelf edge, and a longitudinal lip, the longitudinal lip extending across the front shelf edge, disposed proximal to the front base edge of the base;
a pair of lateral sliding guide rails bars extending between the front and rear base edges of the base, whereby the extendable shelf slides along the lateral sliding guide rails bars to extend and retract, whereby the extendable shelf is operable to extend beyond the front base edge of the base, and retract beneath the base;
a work surface disposed to overlay the base, the work surface defined by a front surface edge, a rear surface edge, and a pair of lateral surface edges, the work surface being at least partially transparent, the work surface having a generally rectangular shape, the work surface including at least one of the following: a tempered blue safety glass, a clear glass, and a black glass;
an illumination portion emitting light towards the work surface;
a ledge extending from the front surface edge of the work surface;
a hinge assembly operable between the front base edge and the front surface edge, the hinge assembly enabling the work surface to pivot between a 0° slope and a 35° slope relative to the base;
a hinged angle adjustment bracket extendable between the base and the work surface, the angle adjustment bracket securing the work surface at a fixed slope, at least a portion of the hinged angle adjustment bracket being fabricated from heavy gauge steel; and
a pair of elongated partitioned lateral trays detachably attachable to the lateral surface edges of the work surface, the partitioned lateral trays defined by a plurality of depressions, the depressions formed in the partitioned lateral trays are defined by at least one of the following shapes: a circular shape, a square, shape, a rectangular shape, and an irregular shape.

20. The drafting table of claim 19, wherein the plurality of modular lower drawers comprise three plastic molded slide-out drawers.
